(19) United States
(12) Patent Application Publication
(10) Pub. No.: US 2012/0125516 A1
(43) Pub. Date: May 24, 2012

(54) DOUBLE BELT SYSTEM AND METHOD FOR OPERATION THEREOF

(75) Inventors: Norbert Wechsler, Munchen (DE); Jens Kompe, Windach (DE); Michael Loferer, Munchen (DE)

(73) Assignee: KraussMaffei Technologies GmbH, Munchen (DE)

(21) Appl. No.: 13/388,253

(22) PCT Filed: Jul. 15, 2010
(86) PCT No.: PCT/EP2010/060171

§ 371 Date: Jan. 31, 2012

(30) Foreign Application Priority Data
Aug. 7, 2009 (DE) 102009036583.4

(51) Int. Cl. B32B 38/18; B32B 37/16

(52) U.S. Cl. 156/60; 156/557

(57) ABSTRACT

A double belt system for producing a prefabricated construction element includes a conveyor system for discontinuously or continuously conveying a first panel, a conveyor system for conveying a first lateral border profile operating as a framework, an application device for applying a foaming plastic material on the first panel and between the first lateral border profile operating as framework and a lateral edge border disposed opposite the first lateral border profile. The double belt system has a top belt and a bottom belt, and at least one protrusion disposed in the belt of the double belt system and facing the first panel and extending circumferentially in the rotation direction of the belt. A recess which is set back in relation to a flat surface is formed in the foamed plastic material with the at least one protrusion.

The present invention relates to a double belt system for producing a prefabricated construction element and a method for its operation.

In particular, simple prefabricated construction elements are increasingly used when constructing very inexpensive houses, in particular in areas with a low income population, which when assembled form walls, ceilings, roofs and the like.

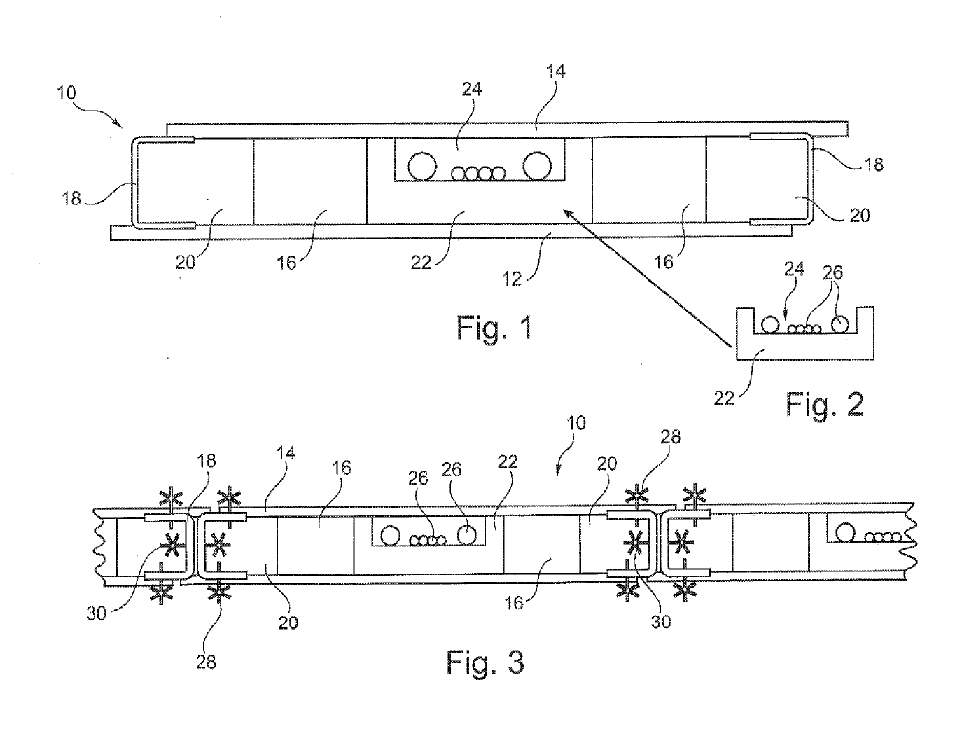

A prefabricated construction element for this type of prefabricated house has been developed in-house which can be used, for example, as a wall element and which is illustrated in FIGS. 1 to 3. In this in-house prefabricated construction element, two outside panels 12 and 14 are joined by interposing foam cores 16 and additionally installing lateral end pieces, wherein the lateral end pieces are constructed such that two abutting prefabricated construction elements can be assembled and affixed to one another with a tight fit, as illustrated in FIG. 3.

FIG. 1 shows the structure of this in-house type of prefabricated construction element. Two prefabricated foamed plastic core elements 16, which are used for spacing and retaining the additional panel 14, are arranged on a panel 12. U-shaped profiles 18 having interior legs extending towards the panel are arranged at the two corresponding side edges and each laterally enclose the prefabricated construction elements. The two panels 12 and 14 alternatingly protrude laterally such that prefabricated construction elements which are aligned with abutting joints are directly connected with one another with a partial overlap, as indicated in FIG. 3.

After the panel is assembled, an insert is pushed into a cavity between the two plastic core elements 16, wherein the insert has a groove-shape recess 24, in which various supply lines 26 are arranged or may be arranged.

The prefabricated construction elements illustrated in FIGS. 1 and 3 are mostly produced discontinuously, wherein initially a panel 12 is prepared, on which the core elements 16 and the U-shaped profile elements 18 are then arranged and covered with the panel 14. Thereafter, the U-shaped profiles 18 are inserted and secured (e.g. screwed together). In a following process step, the insert 22 is inserted.

As seen in FIG. 3, the panels 12 and 14 are screwed together with the U-shaped profiles using screws 28. In addition, the U-shaped profiles 18 themselves are also screwed together.

This production method has several disadvantages. On one hand, it does not enable a continuous process, for example with a double belt press, which is usually more efficient than a discontinuous process. On the other hand, cavities 20 can seldom be prevented when using this production process, where the prefabricated construction element has poor sound and heat insulation.

Regarding the general state-of-the-art, reference is made to U.S. Pat. No. 5,453,231, DE-OS 2 423 792 and DE-OS 2 246 185.

U.S. pat. No. 5,453,231 discloses inter alia a method for producing a foam panel having venting channels. The venting channels are formed with an endless-type conveyor. The endless-type conveyor has conveyor chains and conveyor plates attached to the conveyor chains. In addition, a row of channel-forming plates which are arranged equidistant transversely to the rotation direction and protrude downwardly are provided in order to introduce transverse channels into the foamed panels.

DE-OS 2 423 792 describes a method for producing construction panels made of composite material. First, a continuous belt is produced by joining panels together. Inserts are inserted on this belt when the strip is at rest, and foam bodies are discontinuously applied are glued between the inserts. After going through additional process steps, where inter alfa lateral borders are applied, an exterior side produced in parallel is then applied to this intermediate product. Finally, a press step is performed in a partially moving press, before the continuous belt produced in this manner is cut to length.

DE-OS 2 246 185 describes a device for continuous production of a laminated foam strip, in a double belt facility consisting of an top belt and a bottom belt as well as laterally moving border belts.

It is an object of the present invention to provide a device and a method for producing a prefabricated construction element which eliminates of the aforementioned disadvantages.

This object is attained with the device and method having the features recited in claims 1 and 8.

According to a core concept of the present invention, a prefabricated construction element can be produced efficiently and cost-effectively with a continuous double belt method and can simultaneously have an optimized insulation acoustic and thermal insulation.

In the production process, a lateral border profile used as formwork is first applied on a first panel. Either such lateral border profile is also arranged for the second lateral border, or alternatively the lateral border is implemented on one side by a sealing chain of a double belt system.

The foamable plastic material is then introduced in the regions between the two lateral borders with a suitable conveyor system (e.g. a mixing head) and applied on the panel. This plastic material then foams after entering the double belt, which has a top and a bottom belt, such that the space between the lateral borders of the panel and one belt (mostly the top belt) of the double belt is completely filled.

The belt of the double belt system facing the panel has at least one protrusion arranged continuously and along the entire circumference in the rotation direction of the belt, with the protrusion forming a recess in the foamed plastic material which is set back from an otherwise substantially flat surface.

This technology ensures continuous insulation from one side of the prefabricated construction element to the other side of the prefabricated construction element, wherein channels necessary for inserts or supply lines are incorporated at the same time.

The prefabricated construction element can thus be efficiently and cost-effectively produced with the otherwise conventional double belt method in a continuous manner. Only a panel of the prefabricated construction element and the corresponding border profiles must be conveyed and suitably arranged, thereby readily enabling a foaming process in a limited space inside the double belt.

The additional (e.g. upper) panel can then be applied either before or alternatively after the double belt, thus producing an overall finished prefabricated construction element, whereby this element is additionally adhesively joined by the foamed plastic.

In a first embodiment, lateral border profiles, which form the lateral edge borders of the prefabricated construction element, may be provided on each of the two side edges. Alternatively, a lateral border profile may be provided only on a first side, whereas the border in the double belt on the other side is realized via a lateral sealing chain which moves with the double belt. This embodiment is particularly advantageous when—as will be described later—one of the employed lateral borders of the prefabricated construction element protrudes into a recess of an adjacent panel, thereby allowing an excellent connection between the two panels.

Preferably, the protrusion on the belt of the double belt system is formed by attachment elements which are attached on the belt, for example screwed onto the belt, forming in their entirety a protrusion which is continuous in the rotation direction of the belt. These protrusions can advantageously be exchanged. By applying different attachment elements, differently configured recesses with different cross-sections can be attained. It is then feasible to form two or more smaller recesses, which preferably run in parallel, by using different attachment elements for each double belt panel element.

It is also possible to offset the attachment elements on the belt between two productions with respect to their lateral orientation, whereby the recesses can be introduced at different positions into the prefabricated construction element.

In particular, it is frequently necessary to provide a vapor barrier for exterior walls of houses. For this purpose, a film web extending preferably over the entire width of the element may be provided between the first panel and the foamed plastic material or the second panel and the foamed plastic material. This film web may be conveyed during production already before the double belt system with a conveyor device. In this case, the film web is adhesively bonded with the foaming plastic material. Alternatively the film web may be applied after the double belt system, however, before the second panel is applied.

Because it is desirable to prevent heat bridges, the profiles, i.e. the lateral border profiles or the intermediate profiles, may consist of an insulating material, or they may additionally be coated with an insulating layer, at least in those regions that come into contact with the first and/or the second panels.

A concrete embodiment of the present invention will now be described with reference to the appended drawings. The drawings show in:

FIG. 1 a schematic cross-sectional view through a conventional prefabricated construction element,

FIG. 2 a conventional insert with a recess for a channel in cross-section,

FIG. 3 a schematic cross-sectional view of several abutting construction elements according to FIG. 1,

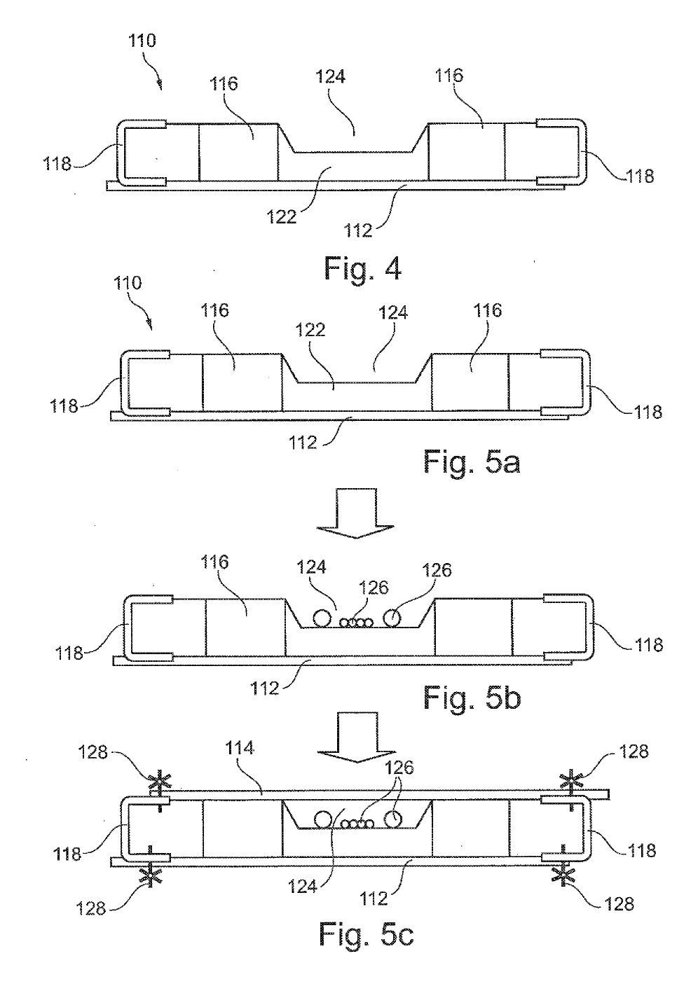

FIG. 4 a schematic cross-sectional view of a first embodiment of a prefabricated construction element according to the invention without a second panel,

FIGS. 5a to 5c schematic cross-sectional views of the first embodiment of the prefabricated construction element according to the invention according to FIG. 4 at different stages of assembly,

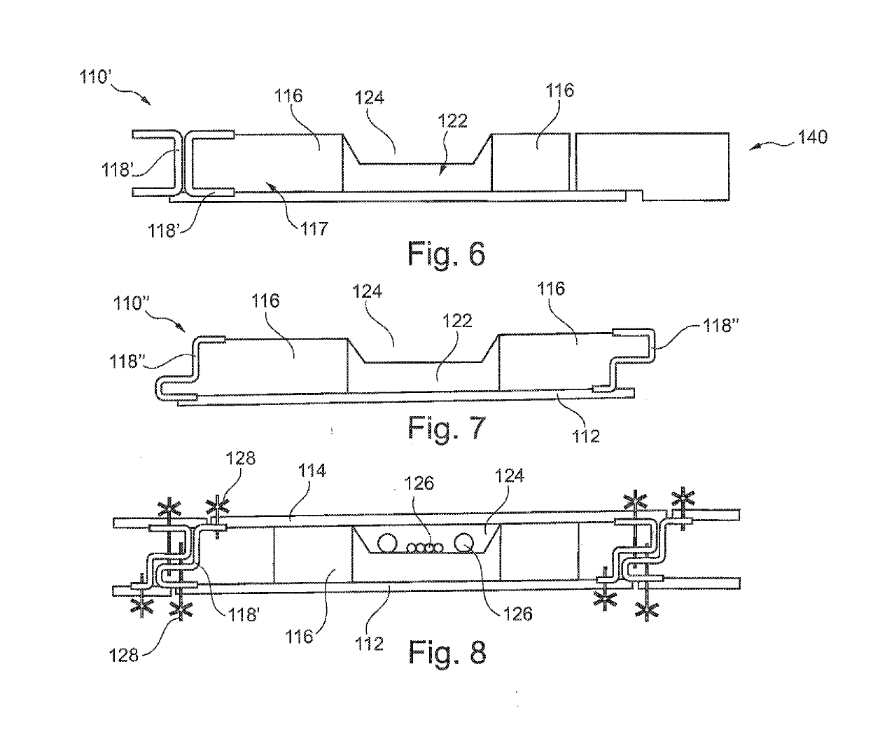

FIG. 6 a schematic cross-sectional view of a second embodiment of a prefabricated construction element according to the invention without a second panel,

FIG. 7 a schematic cross-sectional view of a third embodiment of a prefabricated construction element according to the invention without a second panel, and

FIG. 8 a schematic cross-sectional view of several connected construction elements according to FIG. 7.

FIG. 4 shows in a schematic cross-sectional view a structure of a first embodiment of a prefabricated construction element according to the invention.

The prefabricated construction element is shown with a first panel 112 on the bottom side, two U-shaped border profiles 118 forming the side boundary, and a foamed region with the sections 116, 117 and 122.

The bottom panel 112 protrudes somewhat from the (in the FIG.) left border profile, but does not extend at its right edge to the outermost boundary of the right border profile. In this embodiment, the intermediate product can be removed from the double belt system.

Completion to the finished prefabricated construction element is illustrated in FIGS. 5a to 5c.

First, the supply lines 126 are arranged in the recess 124 (FIG. 5b). Thereafter, a top panel 114 is applied on this intermediate product essentially point-symmetrically with respect to the bottom panel 112, i.e. the top panel 114 protrudes slightly over the (in the FIG.) right border profile, but does not extend at its left edge to the outermost boundary of the left border profile.

With this lateral design, two identical prefabricated construction elements can be butt-joined and connected, for example screwed together, by way of the protruding panel lugs, wherein the respective screw connections can extend through the respective panel (112 or 114) and an adjacent U-shaped element 118 (of the other prefabricated construction element). The protruding panels have also a guiding function when being connected, thereby ensuring a tight joint.

Alternatively to the approach in FIGS. 5a to 5c, the panel 114 can also be applied before the supply lines are introduced, which are then introduced into the recess from above or below at the construction site as needed.

Alternatively, a solid profile can be inserted into the recess 124, particular when no supply lines are to be introduced.

The approach for producing the prefabricated construction element of FIG. 4 is particularly simple. First, the panel 112 is placed on a table or a conveyor system for the double belt arranged before the inlet of a conventional double belt system. The corresponding profiles 118 are conveyed to the panel 112 in a suitable manner and connected with the panel 112, for example with an adhesive.

When the profiles are arranged on the panel 112, a polyurethane material is introduced into the region of the sections 116, 117 and 122, which are to be foamed later, a short distance before the inlet into the conventional double belt which has a top belt and a bottom belt. The reaction time is selected such that foaming is not yet complete before entering the double belt. Complete foaming occurs only after entering the double belt, wherein in the present example the top belt forms the upper boundary for the foam.

The recesses are continuously shaped and formed by the protrusion(s) disposed on a belt of the double belt system. After passing through the double belt, the polyurethane foam is hardened to a degree where the second panel could be placed on the foam and then preferably adhesively bonded with the foam.

FIG. 6 depicts an alternative embodiment of both a production process and the prefabricated construction element itself. The prefabricated construction element is different in that the border profile is missing on the right side of FIG. 5 and preferably a profile having an I-shape or a double C-shape is conveyed on the left side. Because the border profile on the right side is missing, there is no profile performing a framework function; the side is then provided by a lateral sealing chain or sealing caterpillar of the double belt system. This sealing chain 140 moves with the double belt and ensures that the material required for forming the core section 116 in this region does not foam more than necessary.

When the abutting prefabricated construction elements (similar to FIG. 2) are assembled, the left portion of the I-shaped side profile 118′ is now inserted in the free space between the two panels 112 and 114, which has been freed up when the lateral sealing chain was removed, and can be easily screwed together with the panels. This provides a very solid connection between two adjacent plates. Preferably, the foam in this edge region is formed so that the engaging profile of the adjoining prefabricated construction element abuts the foamed material with a form fit.

Another embodiment for a prefabricated construction element is illustrated in FIG. 7. This prefabricated construction element does not differ in the fabrication process, but only in the shape of its two side edges. The side edges are each formed by a stepped profile 118″, wherein a protrusion of one profile can be received in a corresponding recess or a setback of an adjacent profile (similar to a rabbet or a tongue and groove joint). As illustrated in FIG. 8, the panel 114 is applied on these profiles 118″ and partially protrudes, as already described above.

With this design of the prefabricated construction element according to FIG. 7, two adjacent, abutting prefabricated construction elements can be connected with screws, so that the profiles 118″ themselves are connected with each other. Many embodiments with this shape are possible, also with a conventional rabbet or a tongue and groove joint.

With the present invention, a prefabricated construction element can be produced in a simple and cost-effective manner by a continuous method using a double belt system, wherein the prefabricated construction element can be employed in various applications and has excellent properties with respect to sound and heat insulation. In addition, supply lines can already be integrated during pre-installation, preferably when the construction elements are manufactured.

### LIST OF REFERENCES SYMBOLS

10 Prefabricated construction element (state-of-the-art)
12 First panel
14 Second panel
16 Core
18 Side profile (border and reinforcement)
20 Cavity
22 Insert with channel recess
24 Channel recess
26 Supply lines
28 Screw connection first type
30 Screw connection second type
110, 110′ Prefabricated construction element according to the invention
110″
112 First panel
114 Second panel
116 First section of the foamed region
117 Second section of the foamed region
118, 118′ Side profile or edge border profile
118″
122 Third core section with channel recess
124 Channel recess
126 Supply lines
128 Screw connection
140 Lateral sealing chain of the double belt system

What is claimed is:

1-13. (canceled)

14. A double belt system for producing a prefabricated construction element, comprising
a conveyor system for discontinuously or continuously conveying a first panel,
a conveyor system for conveying a first lateral border profile operating as a framework,
an application device for applying a foaming plastic material on the first panel and between the first lateral border profile operating as framework and a lateral edge border disposed opposite the first lateral border profile,
the double belt system having a top belt and a bottom belt, and
at least one protrusion disposed in a belt of the double belt system facing the first panel and extending circumferentially in the rotation direction of the belt, said at least one protrusion operating to form a recess in the foamed plastic material, with the recess being set back in relation to a flat surface.

15. The double belt system of claim 14, wherein the at least one protrusion is formed by an attachment element disposed on the belt or on a belt panel.

16. The double belt system of claim 15, wherein the at least one protrusion is constructed to be removable, exchangeable and/or displaceable.

17. The double belt system of claim 15, further comprising an additional conveyor system for conveying a second lateral border profile disposed opposite the first lateral border profile, wherein the second lateral border profile forms the edge border.

18. The double belt system of claim 15, wherein the double belt system comprises a lateral sealing chain forming the lateral edge border.

19. The double belt system of claim 15, further comprising a conveyor system arranged after the double belt system for discontinuously or continuously conveying a second panel onto the profiles and onto the foamed or foaming plastic material.

20. The double belt system of claim 15, further comprising a conveyor system for conveying a film web forming a vapor barrier, which film web is inserted between the first panel and the foamed or foaming plastic material.

21. The double belt system of claim 19, further comprising a conveyor system for conveying a film web forming a vapor barrier, which film web is inserted between the second panel and the foamed or foaming plastic material.

22. A method for producing a prefabricated construction element, comprising the steps of:
discontinuously or continuously conveying a first panel with a conveyor system,
conveying a first lateral border profile which operates as framework with a conveyor system,
applying a foaming plastic material onto the first panel and introducing the foaming plastic material into a double belt system having a top belt and a bottom belt,
forming a lateral edge border opposite the first lateral border profile, and
forming with at least one protrusion on a belt of the double belt system, with the protrusion rotating in a rotation direction of the belt, a recess in the foamed plastic material, with the recess being set back in relation to a flat surface.

23. The method claim 22, wherein the at least one protrusion comprises differently shaped protrusions, with the differently shaped protrusions forming different recesses.

24. The method claim 22, further comprising the step of conveying a second lateral border profile which is disposed opposite to the first lateral border profile, wherein the second lateral border profile forms the edge border.

25. The method claim 22, wherein the double belt system comprises a lateral sealing chain forming the lateral edge border.

26. The method claim 24, further comprising the step of, after the double belt system, discontinuously or continuously applying a second panel on the first and second lateral border profiles and on the foamed or foaming plastic material.

27. The method claim 22, further comprising the step of introducing a film web is as a vapor barrier between the first panel and the foamed or foaming plastic material.

28. The method claim 22, further comprising the step of introducing a film web is as a vapor barrier between the second panel and the foamed or foaming plastic material.
